(19) United States
(12) Patent Application Publication
(10) Pub. No.: US 2015/0278441 A1
(43) Pub. Date: Oct. 1, 2015

(54) High-order semi-Restricted Boltzmann Machines and Deep Models for accurate peptide-MHC binding prediction

(71) Applicant: NEC Laboratories America, Inc., Princeton, NJ (US)

(72) Inventors: Renqiang Min, Princeton, NJ (US); Pavel Kuksa, Philadelphia, PA (US); Xia Ning, Indianapolis, IN (US)

(21) Appl. No.: 14/512,332

(22) Filed: Oct. 10, 2014

Related U.S. Application Data
(60) Provisional application No. 62/008,713, filed on Jun. 6, 2014.
(60) Provisional application No. 61/969,926, filed on Mar. 25, 2014.

(51) Int. Cl. G06F 19/24; G06N 3/08

(52) U.S. Cl. CPC G06F 19/24; G06N 3/08

(57) ABSTRACT

A method for peptide binding prediction includes receiving a peptide sequence descriptor and descriptors of contacting amino acids on major histocompatibility complex (MHC) protein-peptide interaction structure; generating a model with an ensemble of high order neural network; pre-training the model by high order semi-restricted Boltzmann machine (RBM) or high-order denoising autoencoder; and generating a prediction as a binary output or continuous output with initial model parameters pre-trained using binary output data if available. A systematic learning method for leveraging high-order interactions/associations among items for better collaborative filtering and item recommendation.

This application claims priority to Provisional Application 61/969,926 filed Mar. 25, 2014, and 62/008,713 filed Jun. 6, 2014, the contents of which are incorporated by reference.

### BACKGROUND

Computational methods for antigenic peptide vaccine prediction can significantly reduce cost and time in peptide vaccine search and design in the identification of T-cell epitopes. In this invention, we propose a novel computational framework to efficiently predict which peptides (i.e. short chains of amino acids) from source proteins would bind to major histocompatibility complex (MHC) molecules. The approach covers identification of MHC-binding, naturally processed and presented (NPP), and immunogenic (T-cell epitopes) peptides.

FIG. 1 shows a conventional prediction system. The input to the system is a peptide sequence descriptor or MHC protein-peptide structure descriptor. The input data is provided to a model layer which can be a linear model, a kernel SVM, or an ensemble of traditional feed-forward neural networks. The model generates an output which can be a binary or continuous output.

Previous approaches either use the structures of MHC molecule-peptide complexes, or the sequence information of binding and non-binding peptides, or the combination of structural information and sequence information of the interaction complexes as input features to predict T-cell epitopes. However, most of these approaches are based on linear or bi-linear models, and they fail to capture non-linear dependencies between different amino acids from both MHC molecules and binding peptides. Previous Kernel SVM and Neural Network (NetMHC) approaches for peptide binding prediction can implicitly capture non-linear dependencies between the input features, but they fail to model the direct strong high-order interactions between features. As a result, they often produce low-quality rankings of strong binding peptides. Producing high-quality rankings of peptide vaccine candidates is essential to the successful deployment of computational methods for vaccine design, for which modeling direct non-linear high-order feature interactions is the most important.

In addition, as shown in FIG. 3, explicitly modeling direct high-order interactions is important and effective in collaborative filtering and recommendation but lacking in previous systems.

### SUMMARY

In one aspect, a system to predict peptide-histocompatability complex class (MHC) interaction uses high-order semi-Restricted Boltzmann Machines with deep learning extensions to efficiently predict peptide-MHC binding.

In another aspect, a method for peptide binding prediction includes receiving a peptide sequence descriptor and optional structural descriptor of major histocompatibility complex (MHC) protein-peptide interaction; generating a model with one or an ensemble of high order neural networks; pre-training the model by high-order semi-Restricted Boltzmann machine (RBM) or high-order denoising autoencoder; and generating a prediction as a binary output or continuous output.

Advantages of the above system may include one or more of the following. The peptide-MHC binding prediction methods improve quality of binding predictions over other prediction methods. With the methods, a significant gain of 10-25% is observed on benchmark and reference peptide data sets and tasks. The prediction methods allow integration of both qualitative (i.e., binding/non-binding/eluted) and quantitative (experimental measurements of binding affinity) peptide-MHC binding data to enlarge the set of reference peptides and enhance predictive ability of the method, whereas the existing methods are limited to only less widespread quantitative binding data. As the instant methods are based on the analysis of sequences of known binders and non-binders, the predictive performance will continue to improve with accumulation of the experimentally verified binding/non-binding peptides. This ability to accommodate and scale with increasing amounts of data is critical for further refinement of the prediction ability of the method.

### BRIEF DESCRIPTION OF THE DRAWINGS

FIG. 1 shows a conventional prediction system.

FIG. 2 shows a system with High-order semi-Restricted Boltzmann Machines and Deep Models for accurate peptide-MHC binding prediction.

FIG. 3A shows an exemplary structure of Deep Neural Network (DNN) while FIG. 3B shows an exemplary structure of High-Order Neural Network (HONN) (right).

FIG. 4 shows an exemplary sparse high-order Boltzmann Machine with mean and gated hidden units for collaborative filtering.

### DESCRIPTION

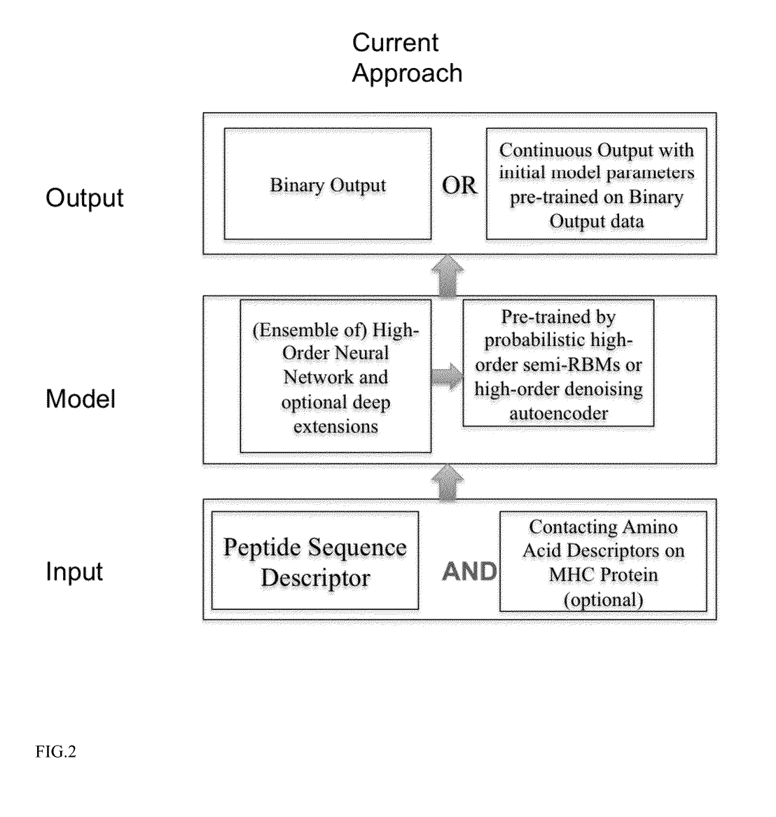

FIG. 2 shows a system with High-order semi-Restricted Boltzmann Machines and Deep Models for accurate peptide-MHC binding prediction. The input to the system is a peptide sequence descriptor and a descriptor of contacting amino acids on MHC protein-peptide interaction structure. The input data is provided to a model layer with one or an ensemble of high order neural networks with optional deep extensions. The model is pre-trained by high order semi-RBMs or high-order denoising autoencoders. The model generates an output which can be a binary output or continuous output with initial model parameters pre-trained using available binary output data.

Given amino acid sequences of test peptides in question and a set of representative peptides with binary binding strengths for the MHC molecule of interest, we use nonlinear high-order machine learning methods including deep neural networks pre-trained with RBMs and High-Order Neural Network (HONN) pre-trained with high-order semi-RBMs with possible deep learning extensions to efficiently predict peptide-MHC binding. The methods cover identification of MHC-binding, naturally processed and presented (NPP), and immunogenic peptides (T-cell epitopes). Here we extend the state-of-the-art deep learning models to model peptide-MHC protein interactions.

Instead of using an ensemble of traditional neural networks to predict MHC class-peptide bindings as in the state-of-the-art approach NetMHC, we use non-linear high-order neural networks and their ensemble combinations with deep extensions if needed, capable of capturing explicit high-order interactions of feature descriptors of both peptides and MHC class proteins, to produce high-quality rankings of predicted binding peptides (T-cell epitopes). In our computational framework, we use either peptide sequence descriptors such as BLOSUM substitution matrix, one-vs-all binary representation of amino acids, and amino acid physiochemical indices alone, or the combination of peptide sequence descriptors and the feature descriptors of contacting amino acids of MHC-class proteins in the corresponding structures of MHC protein-peptide complexes (our experimental results show that our high-order computational framework outperforms NetMHC even only using the feature descriptors of peptide sequences without the help of any structural information of interaction complexes). Our high-order neural networks are pre-trained using High-Order Semi-Restricted Boltzmann Machines (HosRBM) or high-order denoising autoencoders. HosRBM extends traditional RBM to model both mean and high-order interactions of input feature values, and it has different sets of hidden units. Mean hidden units only model mean, and groups of other hidden units, respectively, gate high-order input feature interactions with orders ranging from 2 to m, where m is a user-provided hyper-parameter. If the gating hidden units are binary, they act as binary switches controlling the interactions between input features. We use factorization to reduce the number of parameters for modeling high-order feature interactions. During pre-training, on binary data, fast deterministic damped mean-field update or prolonged Gibbs sampling is used to get samples from hosRBM to perform Contrastive Divergence updates of the connection weights; on continuous data, either Hybrid Monte Carlo (HMC) sampling is used to get samples from probabilistic hosRBM to perform CD updates or denoising autoencoder is used for pre-training to handle arbitrarily higher-order feature interactions. After pre-training the first hidden layer, the activation probabilities of the hidden units can be used as new data to pre-train another standard RBM or another hosRBM and so forth if a deep architecture is needed. The last output layer is a single unit corresponding to either binary output (binding or non-binding) or continuous binding affinity. The network weights are fine-tuned by back-propagation. The size of training data with continuous binding affinities is often small. Given abundant training data with binary outputs and limited training data with continuous binding strength outputs, we first train our model on the binary training data, then we use the learned weights as initialization to train the model on the continuous training data.

We train our model mainly on peptides of a fixed length. For MHC II proteins, the input peptides vary in length. We use sliding window or amino acid skipping to get a bag of peptides of the desired fixed length, then we use simple output score averaging/maximization or multiple instance learning to train our (deep) high-order neural networks for peptide binding prediction.

The peptide-MHC binding prediction methods improve quality of binding predictions over other prediction methods. With the methods, a significant gain is observed on benchmark and reference peptide data sets and tasks. Accurate prediction of high quality (i.e., immunogenic, strong binding) peptides is necessary to accelerate identification and experimental verification of promising peptides for further vaccine and immunotherapy development and lower their costs.

The methods generalize over multiple classes of MHC molecules (i.e., MHC-I and MHC-II) and their allele types. Identification of both MHC-I and MHC-II immunogenic peptides is critical in facilitating the creation of next generation vaccines and immunotherapies. The prediction methods allow integration of both qualitative (i.e., binding/non-binding/eluted) and quantitative (experimental measurements of binding affinity) peptide-MHC binding data to enlarge the set of reference peptides and enhance predictive ability of the method. The methods and similarity metrics are applicable to variable-length peptide data. This ability to work with variable-size data is critical for accurate prediction of inherently diverse binding interactions between peptides and MHC-I and MHC-II molecules. As the methods are based on the analysis of sequences of known binders and non-binders, the predictive performance will continue to improve with accumulation of the experimentally verified binding/non-binding peptides. This ability to accommodate and scale with increasing amounts of data is critical for further refinement of the prediction ability of the method. The methods allow to directly improve quality of retrieved peptides (e.g., according to their binding strength) by re-training specifically on peptides with highest degree of binding affinity.

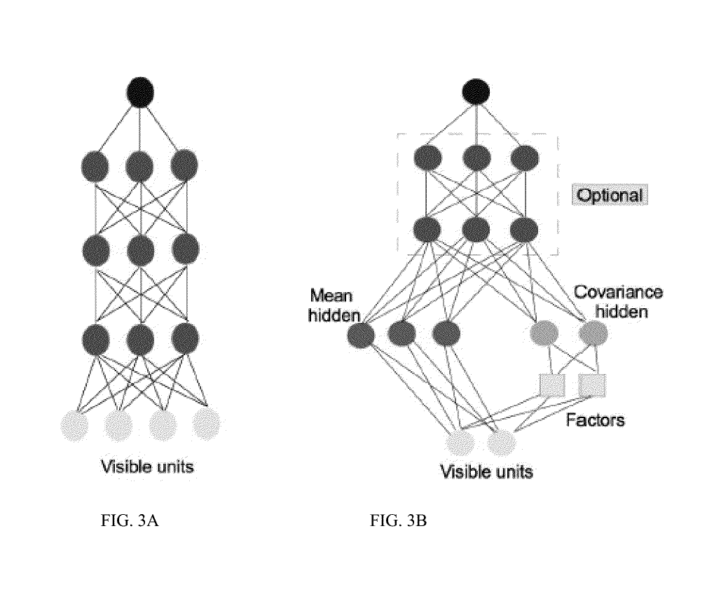

In our Deep Neural Network (DNN) as shown on the left panel of FIG. 3A, we use Gaussian RBM or binary RBM to pre-train the network weights of the first layer depending on the input features are continuous or binary, and we use binary RBM to pre-train the connection weights of upper layers in a greedy layer-wise fashion. In our High-Order Neural Network (HONN) as shown on the right panel of FIG. 3, we use mean-covariance RBM (mcRBM) to pre-train the network weights of the first layer, and we optionally add upper layers if we have enough training data, and we use binary RBM or hosRBM to pre-train the connection weights in possibly available upper layers. In both DNN and HONN, we use a logistic unit as our final output layer, and then we use back-propagation to fine-tune the final network weights by minimizing the cross entropy between predicted binding probabilities and true binding probabilities.

The pre-training module mcRBM of HONN extends traditional Gaussian RBM to model both mean and explicit pairwise interactions of input feature values, and it has two sets of hidden units, mean hidden units modeling the mean of input features and covariance hidden units gating pairwise interactions between input features. If the gating hidden units are binary, they act as binary switches controlling the pairwise interactions between input features.

In the following, we will first review traditional Gaussian RBMs. The energy function of Gaussian RBM is,

$$E ( v , h ) = - {\sum }_{i , j} \frac{{v}_{i}}{{σ}_{i}} {h}_{j} {w}_{ij} - {\sum }_{i} \frac{{( {v}_{i} - {a}_{i} )}^{2}}{2 {σ}_{i}^{2}} - {\sum }_{j} {b}_{j} {h}_{j} , \qquad ( 1 )$$

where i indexes visible units such as peptide sequence features, j indexes hidden units, wᵢⱼ is the network connection weight between visible feature i and hidden unit j, bⱼ is the bias of hidden unit j, and aᵢ and σᵢ are, respectively, the bias and variance of visible feature i. For simplicity, we assume the variance of the visible units to be 1, leading to the energy function,

$$E ( v , h ) = - {\sum }_{i , j} {v}_{i} {h}_{j} {w}_{ij} - {\sum }_{i} \frac{{( {v}_{i} - {a}_{i} )}^{2}}{2} - {\sum }_{j} {b}_{j} {h}_{j} \qquad ( 2 )$$

Using this equation, we can derive the conditional probability distribution of hidden units given visible units as well as the conditional probability distribution of the visible units given the hidden units. Given the hidden units, the visible units are conditionally independent and Gaussian distributed themselves,

$$p ( {v}_{i} \vert h ) = N ( {\sum }_{j} {h}_{j} {w}_{ij} , 1 ) \qquad ( 3 )$$

We use Contrastive Divergence (CD) to learn the network connection weights, which approximately maximizes the log-likelihood of input data. The CD updates for the weights can be written as follows,

wᵢⱼ=ε(<vᵢhⱼ>_{data}−<vᵢhₕ>_{T}), (4)

where is the learning rate, <•>_{data} denotes the expectation with respect to data distribution, and <•>_{T} denotes the expectation with respect to the T-step Gibbs Sampling samples from the model distribution. Binary RBM takes a similar energy function to that of Gaussian RBM except that both visible units and hidden units are binary. As a result, the conditional probability distributions of binary RBM take the form of sigmoid functions.

Gaussian RBMs are very difficult to train using binary hidden units. This is because unlike binary data, continuous valued data lie in a much larger space. One obvious problem with the Gaussian RBM is that given the hidden units, the visible units are assumed to be conditionally independent, meaning it tries to reconstruct the visible units independently without using the abundant covariance information present in all datasets. The knowledge of the covariance information reduces the complexity of the input space where the visible units could lie, thereby helping RBMs to model the continuous distribution more efficiently. Covariance RBM tried to use hidden units to gate the pairwise interaction between the visible units, leading to the following energy function,

$$E ( v , h ) = \frac{1}{2} {\sum }_{i , j , k} {v}_{i} {v}_{j} {h}_{k} {w}_{ijk} - {\sum }_{i} {a}_{i} {v}_{i} - {\sum }_{k} {b}_{k} {h}_{k} \qquad ( 5 )$$

To understand the role of gated hidden units, let us consider the example of natural images. In images nearby pixels are always highly correlated, but presence of an edge or occlusion would make these pixels different. It is this flexibility that the above network is able to achieve, leading to multiple covariances of the dataset. Every state of the hidden units defines a covariance matrix. In case of peptide sequences for predicting binding to MHC proteins, each amino acid feature corresponds to one pixel, and we use hidden units to gate pairwise interactions between different descriptor features across different amino acid positions.

To take advantage of both the Gaussian RBM (which models the mean) and the covariance RBM, the resulting model called mean-covariance RBM (mcRBM) uses an energy function that includes both the energy terms,

$$E ( v , {h}^{g} , {h}^{m} ) = \frac{1}{2} {\sum }_{i , j , k} {v}_{i} {v}_{j} {h}_{k}^{g} {w}_{ijk} - {\sum }_{i} {a}_{i} {v}_{i} - {\sum }_{k} {b}_{k} {h}_{k}^{g} - {\sum }_{ij} {v}_{i} {h}_{j}^{m} {w}_{ij} - {\sum }_{k} {c}_{k} {h}_{k}^{m} \qquad ( 6 )$$

In the above equation, each hidden unit modulates the interaction between each pair of input features leading to a large number of parameters in wᵢⱼₖ to be learned. To reduce this complexity, we can factorize the weight wᵢⱼₖ as follows,

$${w}_{ijk} = {\sum }_{f} {C}_{if} {C}_{\underline{if}} {P}_{kf} \qquad ( 7 )$$

The energy function can now be written as

$$E ( v , {h}^{g} , {h}^{m} ) = \frac{1}{2} {\sum }_{f} {( {\sum }_{i} {v}_{i} {C}_{if} )}^{2} ( {\sum }_{k} {h}_{k} {P}_{kf} ) - {\sum }_{i} {a}_{i} {v}_{i} - {\sum }_{k} {b}_{k} {h}_{k}^{g} - {\sum }_{ij} {v}_{i} {h}_{j}^{m} {w}_{ij} - {\sum }_{k} {c}_{k} {h}_{k}^{m} \qquad ( 8 )$$

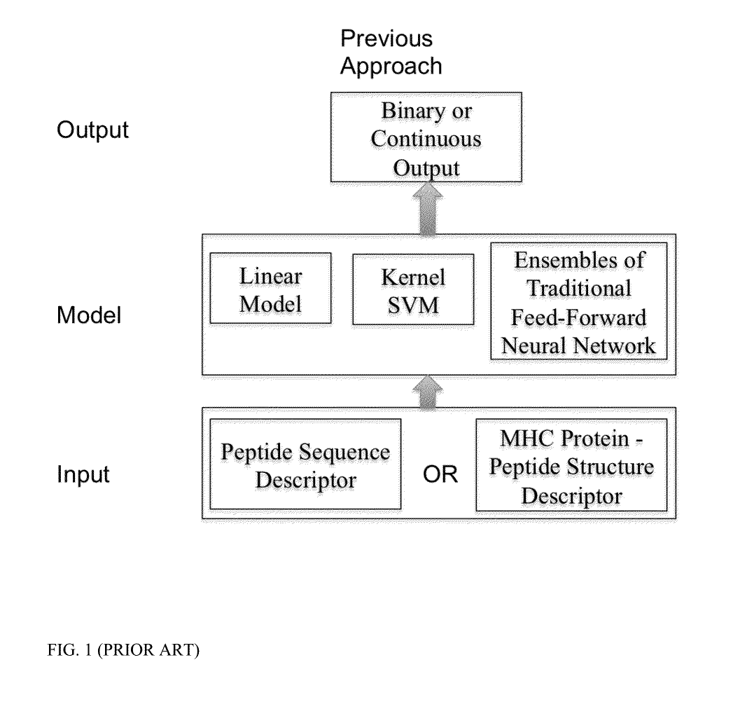

Using this energy function, we can again derive the conditional probabilities of hidden units given visible units, as well the respective gradients for training the network. The structure of this factorized mcRBM is shown on the bottom of the right panel of FIG. 1, the hidden units on the left model mean and those on the right model covariance.

We used CD to learn the factorized weights in mcRBM as in Gaussian RBM, and we used Hybrid Monte Carlo (HMC) sampling to generate the negative samples. The procedure is as follows: given a starting point P₀ and an energy function, the sampler starts at P₀ and moves with randomly chosen velocity along the opposite direction of gradient of the energy function to reach a point Pₙ with low energy. This is similar to the concept of CD, where an attempt is made to reach as close as possible to the actual model distribution. The hyperparameter n denotes the number of leap-frog steps, which we chose to be 20. Since we want to sample from visible units, we need the free energy of the visible units, which can be easily computed by summing out the binary hidden units. We use the samples to calculate the statistics required for learning model parameters.

In order for the peptides to bind to a particular MHC allele (i.e., its peptide-binding groove), the sequences of the binding peptides should be approximately superimposable: contain similar (in some sense, e.g., in the sense of the physicochemical descriptors) amino-acids or strings of amino acids (k-mers) at approximately the same positions along the peptide chain.

It is then natural to model peptide sequences X=x₁, x_{z}, . . . , x_{|X|}, xᵢεΣ (i.e., sequences of amino acid residues) as a sequences of descriptor vectors d₁, . . . , dₙ encoding positions/relevant properties of amino acids observed along the peptide chain.

Then, the sequence of the descriptors corresponding to the peptide X=x₁, x₂, . . . , x_{|X|}, xᵢεΣ can be modeled as an attributed set of descriptors corresponding to different positions (or groups of positions) in the peptide and amino acids or strings of amino acids occupying these positions:

X_{A}={(pᵢ,dᵢ)}ᵢ₌₁ⁿ

where pᵢ is the coordinate (position) or a set (vector) of coordinates and dᵢ is the descriptor vector associated with the pᵢ, with n indicating the cardinality of the attributed set description X_{A} of peptide X. The cardinality of the description X_{A} corresponds to the length of the peptide (i.e., the number of positions) or to in general to the number of unique descriptors in the descriptor sequence representation. A unified descriptor sequence representation of the peptides as a sequence of descriptor vectors is used to derive attributed set descriptions X_{A}.

While the descriptor vectors in general may be of unequal length, in the matrix form (equal-sized vectors) of this representation (“feature-spatial-position matrix”), the rows are indexed by features (e.g., individual amino acids, strings of amino acids, k-mers, physicochemical properties, peptide-MHC interaction features, etc), while the columns correspond to their spatial positions (coordinates).

In this descriptor sequence representation, each position in the peptide is described by a feature vector, with features derived from the amino acid occupying this position/or from a set of amino acids (e.g., a k-mer starting at this position or a window of amino acids centered at this position) and/or amino acids present in the MHC protein molecule and interacting with the amino acids in the peptide.

We define three types of basic descriptors/feature vectors used to construct “feature-position” peptide representations: binary, real-valued, and discrete. These basic descriptors are also used by the kernel functions to measure similarity between individual positions, amino acids, or strings of amino acids.

The purpose of a descriptor is to capture relevant information (e.g., physicochemical properties) that can be used by the kernel functions to differentiate peptides (binding, non-binding, immunogenic, etc).

A simple binary descriptor of an amino acid is a binary indicator vector with zeros at all positions except for one position corresponding to the amino acid which is set to one. An example of the binary matrix representation of the peptide is given in Figure ??.

A real-valued descriptor of an amino acid is a quantitative descriptor encoding (1) relevant properties of amino acids, e.g., their physicochemical properties, and/or (2) interaction features (such as binding energy) between the amino acids in the peptide and in the MHC molecule. An example of the real-valued descriptor sequence representation of a peptide using 5-dim physicochemical amino acid descriptors is given in FIG. 2.

A discrete (or discretized) descriptor of an amino acid or strings of amino acid (k-mer) can, for instance, encode a set of “similar” amino acids or a set of “similar” k-mers, where the set of similar k-mers can be defined as the set of k-mer at a small Hamming distance or with a small substitution or alignment-based distance. Another example of such descriptor is a binary Hamming encoding of amino acids or k-mers.

We concatenate one or multiple types of these feature descriptors of each peptide into a long vector as input data to train our deep learning model.

The nonlinear high-order machine learning methods use Deep Neural Network, and High-Order Neural network with possible deep extensions for peptide-MHC I protein binding prediction. Experimental results on both public and private evaluation datasets according to both binary and non-binary performance metrics (AUC and nDCG) clearly demonstrate the advantages of our methods over the state-of-the-art approach NetMHC, which suggests the importance of modeling nonlinear high-order feature interactions across different amino acid positions of peptides.

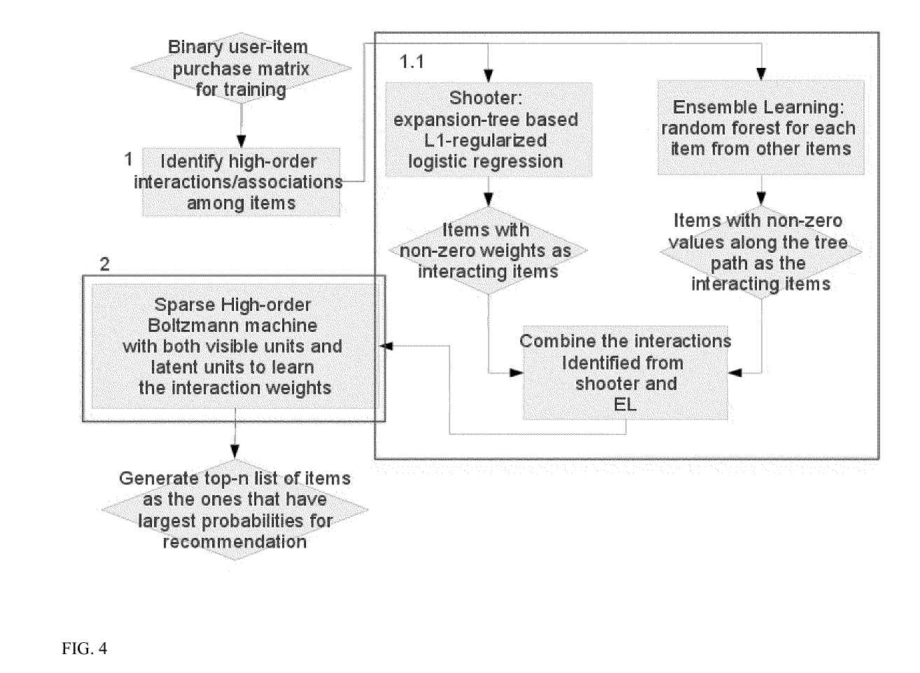

Besides predicting peptide-MHC interaction, a modification of our hosRBM with can be used for collaborative filtering and item recommendation. FIG. 4 shows an exemplary sparse high-order Boltzmann Machine with mean and gated hidden units for collaborative filtering. The process receives a binary user-item purchase matrix for training In 1, the process identifies high order interaction and associations among items. In more details of block 1, the process generates an expansion tree based L1-regularized logistic regression (shooter), and then selects items with non-zero weights as interacting items. In parallel to shooter, the process performs ensemble learning (EL) which a random forest for each item from other items and then selects items with non-zero weights as interacting items. The interactions identified in shooter and EL are combined. The shooter module is described in IR 13004 (application Ser. No. 14/243,918). The EL module is described in IR 12018 (application Ser. No. 13/908,715).

The result is provided to a sparse high order Boltzmann machine with both visible units and latent units to learn the interaction weights in 2. The process then generates top-n list of items as the ones that have the largest probabilities for recommendation.

The system provides a 2-step systematic learning approach for leveraging high-order interactions/associations among items for better collaborative filtering. The first step identifies the high-order interactions/associations among items via a hybrid method that combines regression and Ensemble Learning (EL). The second step learns the interaction/association weights using a Boltzmann machine with latent units.

In the first step, we propose to combine shooter, sparse high-order logistic regression, and Random Forest, to identify a high-quality set of high-order interactions/associations. The shooter method utilizes sparse high-order logistic regression from other items to a certain item of interest to find the interacting items with respect to the interested item as the ones that have non-zero regression weights. The random forest method builds decision trees using the other items to predict the item of interest and identifies the interacting items as the ones whose presence contributes to the presence of the interest items. The high-order interactions/associations identified by both the methods will be combined as the final results of interactions.

In the second step, a sparse high-order Boltzmann machine will be constructed so as to learn the interaction weights. Both the visible units and the latent units including mean hidden units that model visible mean and gated hidden units that model interactions between visible units are included in the Boltzmann machine so as to maximize its power for weight learning. Efficient learning algorithms are proposed to quickly update the model by utilizing the algorithms of damped mean-field updates and parallel Gibbs Sampling based on different local structures of the model.

After the interactions are identified and the weights are learned, they are used to predict the unseen items for each user and take the most likely unseen items as recommendations. Advantages of the system of FIG. 4 may include the following:

1). The 2-step method provides better recommendations by leveraging high-order interactions/associations compared to other collaborative filtering methods.

2). The method is scalable via leveraging the power of parallel computing and thus it is suitable in the Big Data environment.

3). The method represents a working method that is interpretable and efficient for high-order interaction identification.

4). The method can be used for other general-purpose applications where the high-order interactions are expected to exist and play critical roles for better predictions.

The system of FIG. 4 provides more accurate solutions for the collaborative filtering problems in recommender systems where high-order interactions/associations among items are present. The high-order interactions/associations among items have been observed in many applications, for example, in the grocery shopping cases, certain products (e.g., milk, bread and eggs) are often purchased together. Thus, it is reasonable to assume that by leveraging the interactions/associations among items, the performance of collaborative filtering, which is an effective technique that considers all the items from all the users collectively for recommendation purposes, should gain superior performance over its conventional version. However, there lacks a systematical way to automatically identify such high-order interactions/associations and leverage them in a learning process so as to produce high-quality recommendations. This invention attempts to develop novel learning methods that concurrently identify high-order interactions/associations among items and learn from them for better recommendations.

The invention may be implemented in hardware, firmware or software, or a combination of the three. Preferably the invention is implemented in a computer program executed on a programmable computer having a processor, a data storage system, volatile and non-volatile memory and/or storage elements, at least one input device and at least one output device.

Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

What is claimed is:

1. A method for peptide binding prediction, comprising
receiving a peptide sequence descriptor and optional descriptors of contacting amino acids on major histocompatibility complex (MHC) protein-peptide interaction structure;
generating a model with one or an ensemble of high order neural networks;
pre-training the model by high-order semi-Restricted Boltzmann machine (RBM) or high-order denoising autoencoder; and
generating a prediction as a binary output or continuous output with initial model parameters pre-trained using available binary output data.

2. The method of claim 1, comprising modeling with the deep high-order neural network with explicit high-order interactions of feature descriptors of both peptides and MHC class proteins.

3. The method of claim 1, comprising integrating both peptide sequence information and structural information of MHC protein-peptide interaction complexes.

4. The method of claim 1, comprising applying the deep learning model for T-cell epitope prediction.

5. The method of claim 1, comprising pre-training in different modeling stages to improve prediction power.

6. The method of claim 1, comprising integrating both qualitative including binding/non-binding/eluted data and quantitative measurements of binding affinity peptide-MHC binding data to enlarge the set of reference peptides and to enhance predictive ability.

7. The method of claim 1, comprising improving quality of retrieved peptides by re-training specifically on peptides with highest degree of binding affinity.

8. The method of claim 7, comprising retraining according to binding strength.

9. The method of claim 1, comprising deep learning with the ensemble.

10. A method for peptide binding prediction, comprising:
receiving a peptide sequence descriptor and contacting amino acid descriptors on major histocompatibility complex (MHC) protein-peptide interaction structure;
generating a model with one or an ensemble of high-order neural network explicit high-order interactions of feature descriptors of both peptides and MHC class proteins;
pre-training the model by high-order semi-Restricted Boltzmann machine (RBM) or high-order denoising autoencoder;
integrating both peptide sequence information and structural information of MHC protein-peptide interaction complexes;
applying the deep learning model for T-cell epitope prediction; and
generating a prediction as a binary output or continuous output with initial model parameters pre-trained using available binary output data.

11. The method of claim 1, comprising training the model on peptides of a fixed length.

12. The method of claim 1, for MHC II proteins with input peptides that vary in length, comprising using sliding window or amino acid skipping to get a bag of peptides of a desired fixed length, and using output score averaging/maximization or multiple instance learning to train high-order neural networks for peptide binding prediction.

13. The method of claim 1, comprising pre-training using High-Order Semi-Restricted Boltzmann Machines (HosRBM) or high-order denoising autoencoder.

14. The method of claim 13, wherein during pre-training on binary data, comprising using fast deterministic damped mean-field update or prolonged Gibbs sampling to get samples from hosRBM to perform Contrastive Divergence updates of connection weights;

15. The method of claim 13, wherein during pre-training on continuous data, comprising using either Hybrid Monte Carlo (HMC) sampling to get samples from probabilistic hosRBM to perform CD updates or denoising autoencoder for pre-training to handle arbitrarily higher-order feature interactions.

16. The method of claim 13, wherein the HosRBM model both mean and high-order interactions of input feature values with different sets of hidden units.

17. The method of claim 1, comprising applying factorization to reduce the number of parameters for modeling high-order feature interactions.

18. The method of claim 1, comprising determining if gating hidden units are binary, and if so controlling interactions between input features as binary switches.

19. The method of claim 1, after pre-training the first hidden layer, comprising using activation probabilities of hidden units as new data to pre-train another standard RBM for a deep architecture.

20. The method of claim 1, comprising fine-tuning network weights by back-propagation, and given training data with binary outputs and limited training data with continuous binding strength outputs, training the model on the binary training dataset, then using the learned weights as initialization to train the model on a continuous training dataset.

21. A systematic learning method for leveraging high-order interactions/associations among items for better collaborative filtering and item recommendation, comprising
identifying high-order interactions or associations among items with a hybrid structure learning method that combines sparse high-order logistic regression and Ensemble Learning (EL); and
learning interaction/association weights using a high-order Boltzmann machine with latent units.
